(19) United States
(12) Patent Application Publication
(10) Pub. No.: US 2015/0103468 A1
(43) Pub. Date: Apr. 16, 2015

(54) MULTILAYER CERAMIC ELECTRONIC COMPONENT AND METHOD OF MANUFACTURING THE SAME

(71) Applicant: SAMSUNG ELECTRO-MECHANICS CO., LTD., Suwon (KR)

(72) Inventor: Seok Joon HWANG, Suwon-Si (KR)

(73) Assignee: SAMSUNG ELECTRO-MECHANICS CO., LTD., Suwon (KR)

(21) Appl. No.: 14/224,962

(22) Filed: Mar. 25, 2014

(30) Foreign Application Priority Data
Oct. 11, 2013 (KR) 10-2013-0121227

(51) Int. Cl. H01G 4/005

(52) U.S. Cl. CPC H01G 4/005
USPC 361/321.2; 29/25.42

(57) ABSTRACT

A multilayer ceramic electronic component may include: a ceramic body including a plurality of dielectric layers; and first and second internal electrodes disposed to be alternately exposed to both end surfaces of the ceramic body, having at least one of the dielectric layers interposed therebetween. The second internal electrode may include a space part disposed to be adjacent to a portion thereof exposed to one end surface of the ceramic body so as to be not overlapped with the first internal electrode in the space part.

### CROSS-REFERENCE TO RELATED APPLICATION

This application claims the benefit of Korean Patent Application No. 10-2013-0121227 filed on Oct. 11, 2013, with the Korean Intellectual Property Office, the disclosure of which is incorporated herein by reference.

### BACKGROUND

The present disclosure relates to a multilayer ceramic electronic component and a method of manufacturing the same.

As electronic components using a ceramic material, there are a capacitor, an inductor, a piezoelectric element, a varistor, a thermistor, and the like.

Among ceramic electronic components, a multilayer ceramic capacitor (MLCC) has advantages such as a small size, high capacitance, easiness of mounting, and the like.

A multilayer ceramic capacitor is a chip-type condenser mounted on a circuit board of electronic products such as a computer, a personal digital assistant (PDA), a cellular phone, or the like, to perform an important role of charging electricity therein or discharging electricity therefrom, and a size and a stacked form thereof may vary according to intended use and capacitance.

Particularly, as electronic products have been miniaturized, microminiaturization and high capacitance of multilayer ceramic capacitors used therein have been required.

Therefore, a multilayer ceramic capacitor is manufactured to have dielectric layers and internal electrodes of which thicknesses are reduced in order to allow an electronic product miniaturized and to have an increased number of dielectric layers stacked therein in order to achieve high capacitance in the electronic product.

As the multilayer ceramic capacitor is miniaturized, the thicknesses of the dielectric layers are reduced, such that breakdown voltage (BDV) and electrostatic discharge (ESD) properties may be deteriorated.

Further, distribution of areas overlapped between upper and lower internal electrodes may occur due to a reduction in precision of a printing or stacking process at the time of stacking and pressing the internal electrodes during a process of manufacturing the multilayer ceramic capacitor. In the case of a small chip, the distribution of the areas overlapped between the internal electrodes may be more sensitive to the precision of the printing or stacking process, resulting in uneven capacitance distribution.

### SUMMARY

An aspect of the present disclosure may provide a multilayer ceramic electronic component capable of suppressing a decrease in breakdown voltage (BDV) and electrostatic discharge (ESD) properties resulting from miniaturization of the multilayer ceramic electronic component and of decreasing the occurrence of uneven capacitance distribution by reducing an influence of precision in printing and stacking processes and allowing overlap areas between upper and lower internal electrodes to be significantly uniform.

According to an exemplary embodiment in the present disclosure, a multilayer ceramic electronic component may include: a ceramic body including a plurality of dielectric layers; and first and second internal electrodes disposed to be alternately exposed to both end surfaces of the ceramic body, having at least one of the dielectric layers interposed therebetween, wherein the second internal electrode includes a space part disposed to be adjacent to a portion thereof exposed to one end surface of the ceramic body so as to be not overlapped with the first internal electrode in the space part.

The first and second internal electrodes may have the same width.

The first internal electrode may include a space part disposed to be adjacent to a portion thereof exposed to the other end surface of the ceramic body so as to be not overlapped with the second internal electrode.

The multilayer ceramic electronic component may further include first and second external electrodes formed on the end surfaces of the ceramic body and connected to the first and second internal electrodes, respectively.

When a width of the second internal electrode is defined as W and a width of the space part is defined as W′, W′/W may be 0.7 or less.

According to an exemplary embodiment in the present disclosure, a method of manufacturing a multilayer ceramic electronic component may include: forming a plurality of first internal electrode films on a first ceramic sheet at a predetermined interval; forming a plurality of second internal electrode films on a second ceramic sheet at a predetermined interval, each second internal electrode film including a second space part; preparing a multilayer body by stacking a plurality of the first and second ceramic sheets to be alternately offset in a length direction and pressing the stacked sheets; preparing a ceramic body having first and second internal electrodes by cutting the multilayer body to separate regions thereof corresponding to individual chips while the first and second internal electrode films are alternately exposed to both end surfaces of the ceramic body; and sintering the ceramic body, wherein the multilayer body is cut so that the second space part is positioned adjacent to a portion of the second internal electrode film exposed to one end surface of the ceramic body.

The first and second internal electrode films may be formed to have the same width.

Each of the plurality of first internal electrode films formed on the first ceramic sheet may include a first spaced part, and the multilayer body may be cut so that the first space part is positioned adjacent to a portion of the first internal electrode film exposed the other end surface of the ceramic body.

The method may further include forming first and second external electrodes on the end surfaces of the ceramic body to be connected to the first and second internal electrodes, respectively.

According to an exemplary embodiment in the present disclosure, a method of manufacturing a multilayer ceramic electronic component may include: forming a plurality of first internal electrode films including two adjacent first space parts on a first ceramic sheet at a predetermined interval; forming a plurality of second internal electrode films including two adjacent second space parts on a second ceramic sheet at a predetermined interval; preparing a multilayer body by stacking a plurality of the first and second ceramic sheets while the first and second space parts are alternately offset in a length direction and pressing the stacked sheets; preparing a ceramic body having first and second internal electrodes by cutting the multilayer body to separate regions thereof corresponding to individual chips while the first and second internal electrode films are alternately exposed to both end surfaces of the ceramic body; and sintering the ceramic body, wherein the multilayer body is cut so that the first and second space parts are positioned adjacent to portions of the first and second internal electrode films exposed to the end surfaces of the ceramic body, respectively.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view illustrating a structure of a multilayer ceramic capacitor according to an exemplary embodiment of the present disclosure;

FIG. 2 is a cross-sectional view taken along line A-A′ of FIG. 1;

FIG. 3 is an exploded perspective view schematically illustrating a stacked structure of first and second internal electrodes in a multilayer ceramic capacitor according to an exemplary embodiment of the present disclosure;

FIG. 4 is an assembled perspective view of the first and second internal electrodes of FIG. 3;

FIG. 5 is a plan view illustrating a structure in which first and second internal electrode films are disposed in a method of manufacturing a multilayer ceramic capacitor according to an exemplary embodiment of the present disclosure;

FIG. 6 is a plan view illustrating a region selected from the structure of FIG. 5 cut in a chip form;

FIG. 7 is a plan view illustrating a structure in which first and second internal electrode films are disposed in a method of manufacturing a multilayer ceramic capacitor according to another exemplary embodiment of the present disclosure;

FIG. 8 is a plan view showing a region selected from the structure of FIG. 7 cut in a chip form;

FIG. 9 is a side cross-sectional view illustrating a multilayer ceramic capacitor according to another exemplary embodiment of the present disclosure;

FIG. 10 is a graph illustrating changes in breakdown voltage (BDV) with respect to widths of a space part and an internal electrode; and

FIGS. 11 through 13 are graphs illustrating distribution of capacitance in multilayer ceramic capacitors according to sizes of space parts, respectively.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

The present disclosure relates to a multilayer ceramic electronic component. Examples of a multilayer ceramic electronic component according to an exemplary embodiment of the present disclosure may include a multilayer ceramic capacitor, an inductor, a piezoelectric element, a varistor, a chip resistor, a thermistor, or the like. Hereinafter, a multilayer ceramic capacitor will be described as an example of the multilayer ceramic electronic component.

In this exemplary embodiment, for convenience of explanation, surfaces of a ceramic body opposing each other in a thickness direction may be defined as first and second main surfaces, surfaces of the ceramic body connecting the first and second main surfaces to each other and opposing each other in a length direction may be defined as first and second end surfaces, and surfaces of the ceramic body opposing each other in a width direction while vertically intersecting with the first and second end surfaces may be defined as first and second side surfaces.

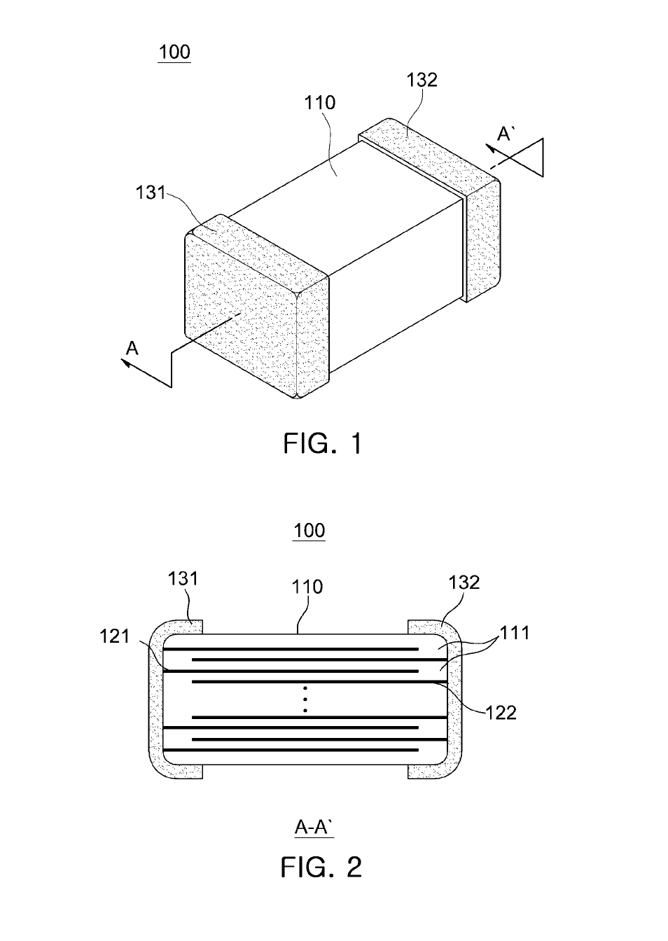

FIG. 1 is a schematic perspective view illustrating a structure of a multilayer ceramic capacitor according to an exemplary embodiment of the present disclosure, and FIG. 2 is a cross-sectional view taken along line A-A′ of FIG. 1.

Referring to FIGS. 1 and 2, a multilayer ceramic capacitor 100 according to this exemplary embodiment may include a ceramic body 110 in which a plurality of dielectric layers 111 are stacked; and a plurality of first and second internal electrodes 121 and 122 disposed within the ceramic body 110 with the dielectric layer 111 interposed therebetween, alternately exposed to the first and second end surfaces of the ceramic body 110, and having different polarities from each other.

In this case, first and second external electrodes 131 and 132, electrically connected to the first and second internal electrodes 121 and 122, respectively, may be formed on the first and second end surfaces of the ceramic body 110.

The ceramic body 110 may be formed by stacking the plurality of dielectric layers 111 in the thickness direction and then sintering the same. In addition, a shape and a dimension of the ceramic body 110 and the number of stacked dielectric layers 111 are not limited to those illustrated in this exemplary embodiment.

In addition, the plurality of dielectric layers 111 forming the ceramic body 110 may be in a sintered state. Adjacent dielectric layers 111 may be integrated such that boundaries therebetween are not readily apparent without using a scanning electron microscope (SEM).

A shape of the ceramic body 110 is not particularly limited, but may be, for example, a hexahedral shape.

The dielectric layers 111 may contain ceramic powder having high permittivity, for example, barium titanate (BaTiO₃) based powder or strontium titanate (SrTiO₃) based powder, or the like, but the present disclosure is not limited thereto as long as sufficient capacitance may be obtained.

In addition, the dielectric layers 111 may further contain various ceramic additives such as transition metal oxides or carbides, a rare earth element, magnesium (Mg), aluminum (Al), or the like, an organic solvent, a plasticizer, a binder, a dispersant, or the like, in addition to the ceramic powder, as necessary.

Furthermore, an average thickness of the dielectric layers 111 may be changed according to a target capacitance of the multilayer ceramic capacitor 100.

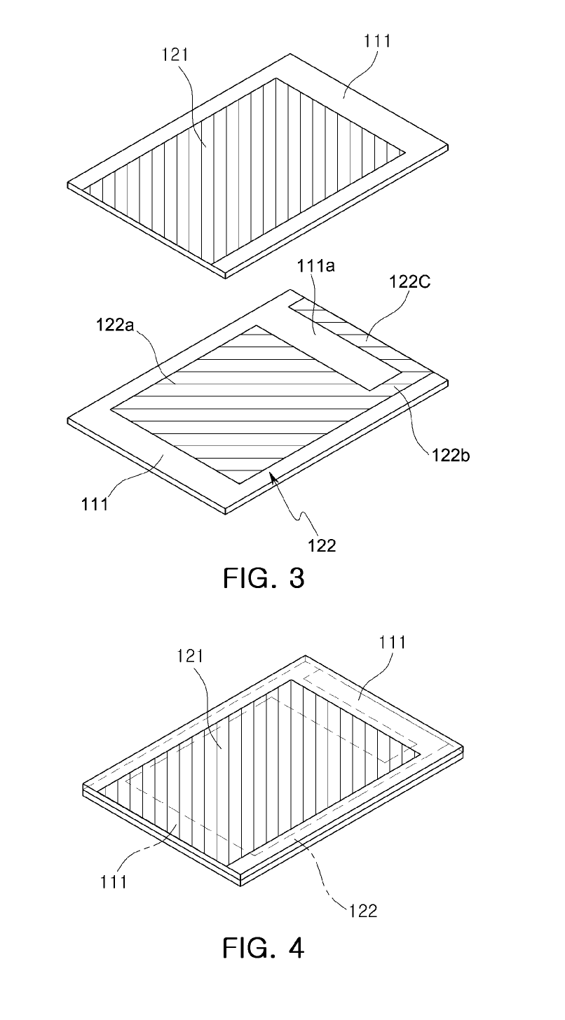

FIG. 3 is an exploded perspective view schematically illustrating a stacked structure of first and second internal electrodes in the multilayer ceramic capacitor according to the exemplary embodiment of the present disclosure, and FIG. 4 is an assembled perspective view of the first and second internal electrodes of FIG. 3.

Referring to FIGS. 3 and 4, the first and second internal electrodes 121 and 122 having different polarities may be formed by printing a conductive paste containing a conductive metal on the dielectric layers 111 at a predetermined thickness.

Further, the first and second internal electrodes 121 and 122 may be formed to have the same width as each other in order to significantly increase an overlap area therebetween when they are disposed vertically while securing a predetermined margin part, but the present disclosure is not limited thereto.

In this case, the first and second internal electrodes 121 and 122 may be alternately exposed to both end surfaces of the ceramic body 110 while being stacked with the dielectric layer 111 interposed therebetween. In this case, the first and second internal electrodes 121 and 122 may be insulated from each other by the dielectric layer 111 interposed therebetween.

Further, the first and second internal electrodes 121 and 122 may be electrically connected to the first and second external electrodes 131 and 132 through the portions thereof alternately exposed to both end surfaces of the ceramic body 110, respectively.

In this case, the second internal electrode 122 may include a body part 122a forming capacitance while being overlapped with the first internal electrode 121 and a lead part 122c exposed to the second end surface of the ceramic body 110.

The body part 122a and the lead part 122c may be connected to a connection part 122b having a predetermined width, and a second space part 111a may be formed between the body part 122a and the lead part 122c so as not to be overlapped with first internal electrodes 121 vertically disposed.

According to another exemplary embodiment, the first internal electrode 121 may have the same structure as that of the second internal electrode 122. That is, the first internal electrode 121 may have a first space part (not shown) adjacent to a portion thereof exposed to the first end surface of the ceramic body 110 so as not to be overlapped with the second internal electrode 122. Since the structure of the first internal electrode 121 is symmetrical to that of the second internal electrode 122 in the length direction, a detailed description thereof will be omitted.

The first and second external electrodes 131 and 132 may be formed on the first and second end surfaces of the ceramic body 110 and contact the exposed portions of the first and second internal electrodes 121 and 122, respectively, to thereby be electrically connected thereto.

The first and second external electrodes 131 and 132 may be formed of a conductive paste including a conductive metal, wherein the conductive metal may be silver (Ag), nickel (Ni), copper (Cu), or an alloy thereof, but the present disclosure is not limited thereto.

Meanwhile, a plating layer (not shown) may be formed on the first and second external electrodes 131 and 132, as necessary.

The plating layer is intended to increase adhesion strength between the multilayer ceramic capacitor 100 and a printed circuit board at the time of mounting the multilayer ceramic capacitor 100 on the printed circuit board using solder.

The plating layer may have a structure configured of a nickel (Ni) plating layer formed on the first and second external electrodes 131 and 132 and a tin (Sn) plating layer formed on the nickel plating layer, respectively, but the present disclosure is not limited thereto.

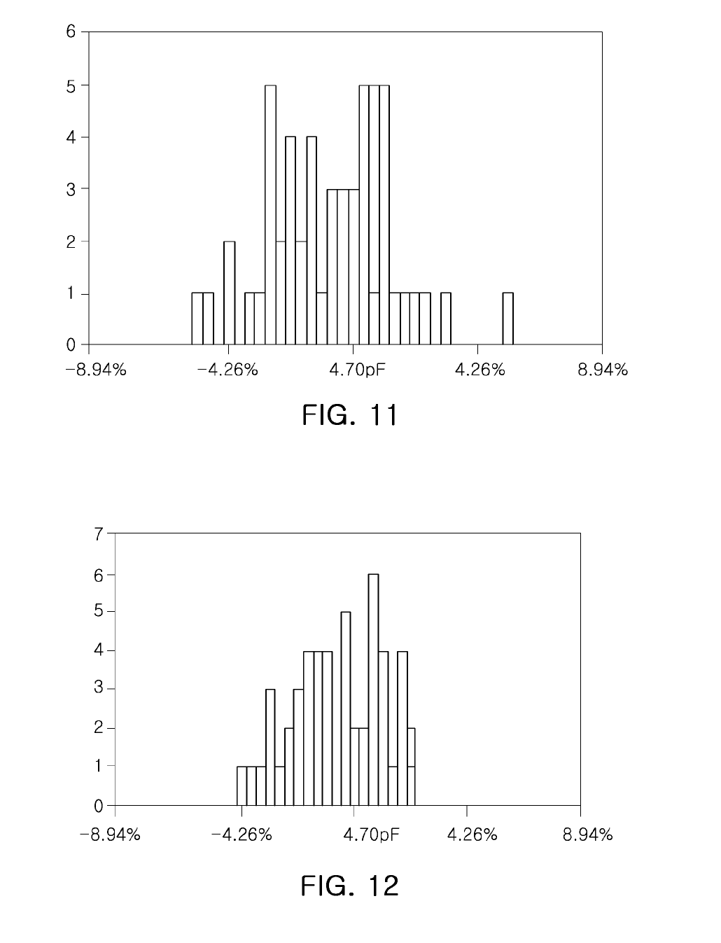

FIGS. 11 through 13 are graphs illustrating distribution of capacitance in multilayer ceramic capacitors according to sizes of space parts, respectively.

In FIGS. 11 through 13, a chip having a size of 4×2 mm, COG characteristics, and 4.7 pF (capacitance standard ±4.26%) was used.

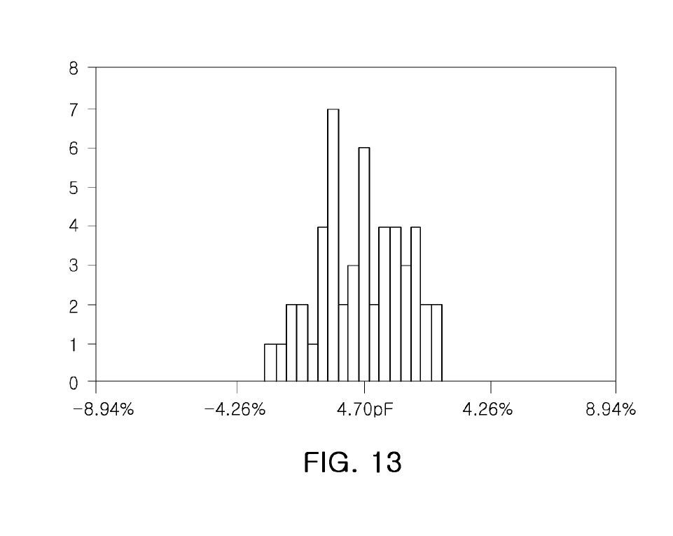

FIG. 11 illustrates distribution of capacitance in an existing multilayer ceramic capacitor having no space part, FIG. 12 illustrates distribution of capacitance in a multilayer ceramic capacitor including a space part having a size of 10 μm, and FIG. 13 illustrates distribution of capacitance in a multilayer ceramic capacitor including a space part having a size of 20 μm.

Referring to FIGS. 11 through 13, a process capability index Cp of a capacitance value was 0.56, 0.81, and 0.96 in FIGS. 11 through 13, respectively. Therefore, it may be seen that as the size of the space part is increased, Cp is also improved.

Hereinafter, a method of manufacturing a multilayer ceramic capacitor according to an exemplary embodiment of the present disclosure will be described.

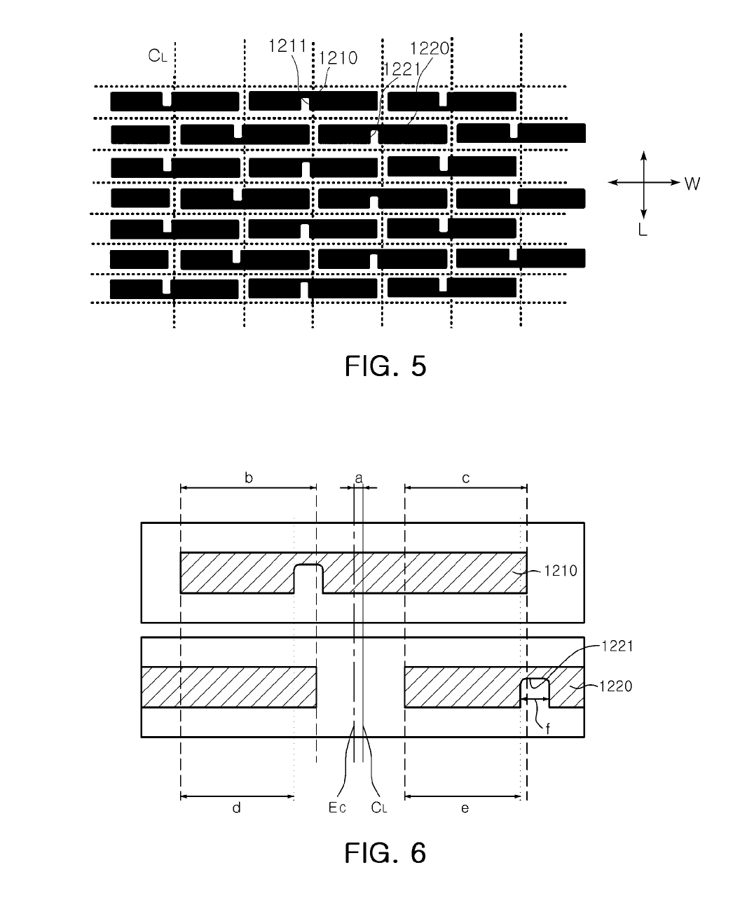

FIG. 5 is a plan view showing a structure in which first and second internal electrode films are disposed in a method of manufacturing a multilayer ceramic capacitor according to an exemplary embodiment of the present disclosure, and FIG. 6 is a plan view showing a region selected from the structure of FIG. 5 cut in a chip form.

Referring to FIGS. 5 and 6, first, a plurality of first and second ceramic sheets may be prepared. The ceramic sheets are used to form the dielectric layers 111 in the ceramic body 110.

The first and second ceramic sheets may be manufactured by mixing a ceramic powder, a polymer, and a solvent to prepare slurry and forming the prepared slurry as sheets having a thickness of several μm by a doctor blade method, or the like.

Thereafter, first and second internal electrode films 1210 and 1220 may be formed at a predetermined interval by printing a conductive paste on the first and second ceramic sheets at a predetermined thickness, for example, 0.1 to 2.0 μm, but the thickness of the first and second internal electrode films 1210 and 1220 is not limited thereto.

The conductive paste may contain metal powder, ceramic powder, silica (SiO₂) powder, and the like. In addition, the metal powder may be formed of any one of silver (Ag), palladium (Pd), platinum (Pt), nickel (Ni), and copper (Cu), an alloy thereof, or the like. Meanwhile, the internal electrode films may be formed by printing the conductive paste on the ceramic sheets using a screen printing method, a gravure printing method, or the like.

Here, the first and second internal electrode films 1210 and 1220 may be formed to have the same width, but the present disclosure is not limited thereto.

In addition, the first and second internal electrode films 1210 and 1220 may have first and second space parts 1211 and 1221, respectively. Although the case in which both of the first and second internal electrode films have the space parts is described in this exemplary embodiment, the present disclosure is not limited thereto. If necessary, only the first or second internal electrode film may have the space part.

Next, a plurality of first and second ceramic sheets on which the first and second internal electrode films 1210 and 1220 are formed, respectively, may be stacked to be alternately offset in a length direction and be pressed at high temperature and high pressure, thereby preparing a multilayer body.

Then, the multilayer body may be cut in a cutting line CL of FIG. 5 for each region corresponding to a single chip so that the first and second internal electrode films 1210 and 1220 are alternately exposed to respective end surfaces and may be sintered and polished to thereby form the ceramic body 110 in which the first and second internal electrodes 121 and 122 are alternately exposed to the first and second end surfaces of the ceramic body 110.

In this case, the second internal electrode film 1220 of the multilayer body may be cut so that the second space part 1221 is positioned adjacent to a portion exposed to one end surface of the ceramic body, and the first internal electrode film 1210 may be cut so that the first space part 1211 is positioned adjacent to a portion exposed to the other end surface of the ceramic body.

In a method of manufacturing a multilayer ceramic capacitor according to the related art, first and second internal electrode films are stacked to be alternately offset to each other and regions of the lamination, corresponding to single chips, are cut for the formation thereof. In this case, positions of vertically adjacent first and second internal electrode films may be altered and displaced at the time of being stacked, and thus, an electric field may be concentrated and a difference in areas overlapped between the first and second internal electrodes may occur, whereby uneven distribution of capacitance in the multilayer ceramic capacitor may occur. In addition, when voltage is applied to the multilayer ceramic capacitor, the electric field may be concentrated on ends of the first and second internal electrodes of the multilayer ceramic capacitor, and thus, the dielectric layers may be broken, resulting in deterioration in breakdown voltage (BDV) and electrostatic discharge (ESD) properties of the chip.

However, according to this exemplary embodiment, as shown in FIG. 6, each internal electrode printed pattern may include a non-printed pattern portion having a width f larger than an offset portion a of the electrode pattern. The non-printed pattern portion may form the space part 1221, and the space part 1221 may allow the vertically adjacent internal electrode films to not be overlapped with one another. Since the space part 1221 does not contribute to forming capacitance, the space part may prevent deviation in the overlap areas between the stacked internal electrodes due to the offset portion a, thereby decreasing the occurrence of uneven distribution of capacitance.

Here, Ec denotes a central line of an internal electrode printing pattern, b and c denote the maximum overlap area and the minimum overlap area in the multilayer ceramic capacitor having no space part according to the related art, respectively, and d and e denote improved overlap areas according to this exemplary embodiment. In this case, the overlap areas d and e may be the same as each other.

Meanwhile, as in this exemplary embodiment, in the case in which two non-printed pattern portions are formed, portions of the ceramic body 110 corresponding to end portions of the first and second internal electrodes on which an electric field is concentrated may have reduced thicknesses, whereby a decrease in BDV or ESD may be suppressed.

Next, the first and second external electrodes 131 and 132 may be formed to contact portions of the plurality of first and second internal electrodes 121 and 122 exposed to the first and second end surfaces of the ceramic body 110 to thereby be electrically connected thereto, respectively.

Here, a plating layer may be further formed on the first and second external electrodes 131 and 132, as necessary.

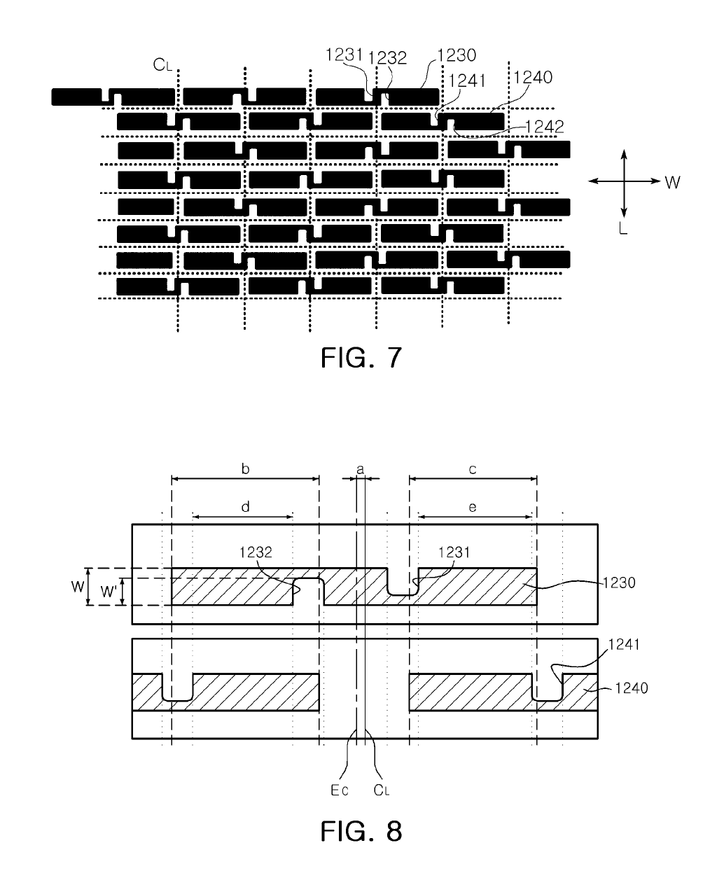

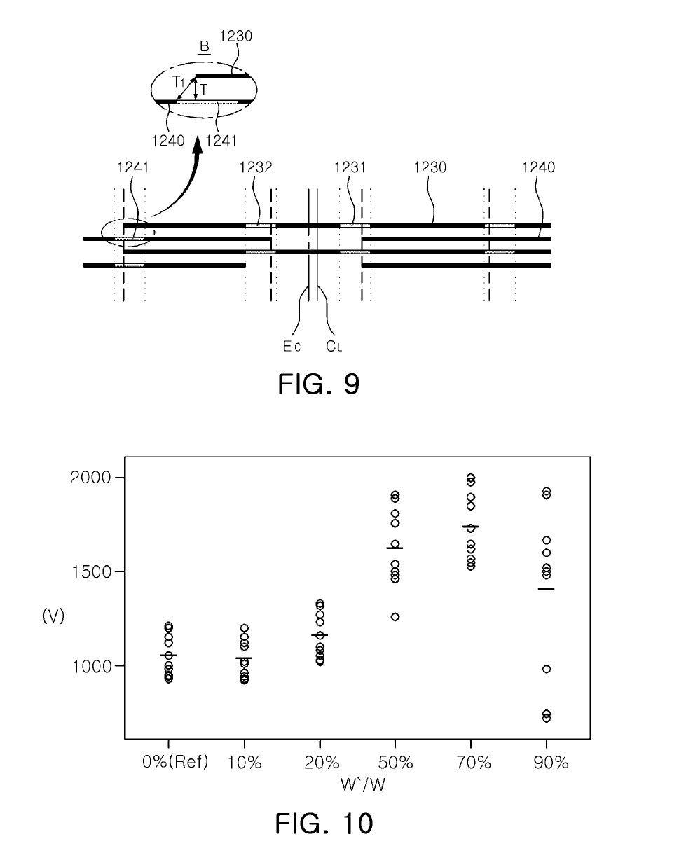

FIG. 7 is a plan view illustrating a structure in which first and second internal electrode films are disposed in a method of manufacturing a multilayer ceramic capacitor according to another exemplary embodiment of the present disclosure, FIG. 8 is a plan view illustrating a region selected from the structure of FIG. 7 cut in a chip form, and FIG. 9 is a side cross-sectional view illustrating a multilayer ceramic capacitor according to another exemplary embodiment of the present disclosure.

Referring to FIGS. 7 through 9, a plurality of first and second ceramic sheets may be prepared. The ceramic sheets are used to form the dielectric layers 111 within the ceramic body 110.

The first and second ceramic sheets may be manufactured by mixing a ceramic powder, a polymer, and a solvent to prepare slurry and forming the prepared slurry as sheets having a thickness of several μm by a doctor blade method, or the like.

Thereafter, first and second internal electrode films 1230 and 1240 may be formed at a predetermined interval by printing a conductive paste on the first and second ceramic sheets at a predetermined thickness, for example, 0.1 to 2.0 μm, but the thickness of the first and second internal electrode films 1230 and 1240 is not limited thereto.

In this case, the first and second internal electrode films 1230 and 1240 may be formed to have the same width as each other, but the present disclosure is not limited thereto.

In addition, the first internal electrode film. 1230 may have two adjacent first space parts 1231 and 1232, and the second internal electrode film 1240 may have two adjacent second space parts 1241 and 1242. Although the case in which both of the first and second internal electrode films have the space parts is described in this exemplary embodiment, the present disclosure is not limited thereto. If necessary, only the first or second internal electrode film may have the space parts.

Next, a plurality of first and second ceramic sheets on which the first and second internal electrode films 1230 and 1240 are formed, respectively, may be stacked to be alternately offset in a length direction and pressed at high temperature and high pressure, thereby preparing a multilayer body.

Then, the multilayer body may be cut in the cutting line CL for each region corresponding to a single chip while the first and second internal electrode films 1230 and 1240 are allowed to be alternately exposed to first and second end surfaces and be sintered and polished, thereby preparing the ceramic body 110 in which the first and second internal electrodes 121 and 122 are formed to be alternately exposed to the first and second end surfaces.

Here, the second internal electrode film 1240 of the multilayer body may be cut so that the second space part 1241 is positioned adjacent to a portion exposed to one end surface of the ceramic body, and the first internal electrode film 1230 may be cut so that the first space part 1231 is positioned adjacent to a portion exposed to the other end surface of the ceramic body.

Here, Ec denotes a central line of an internal electrode printing pattern, b and c denote the maximum overlap area and the minimum overlap area in the multilayer ceramic capacitor having no space part according to the related art, respectively, and d and e denote improved overlap areas according to this exemplary embodiment. In this case, the overlap areas d and e may be the same as each other.

The following Table 1 and FIG. 10 show BDV measurement results according to changes in a ratio of a width W′ of the space part shown in FIG. 8 to a width W of the internal electrode from 0% to 90%.

TABLE 1

| | W′/W | | | | | |
|---|---|---|---|---|---|---|
| | 0% | 10% | 20% | 50% | 70% | 90% |
| Average | 1,053 | 1,035 | 1,159 | 1,626 | 1,738 | 1,405 |
| BDV | | | | | | |
| 1 | 1,000 | 1,150 | 1,100 | 1,260 | 1,650 | 1,600 |
| 2 | 1,120 | 920 | 1,230 | 1,760 | 1,850 | 740 |
| 3 | 1,150 | 930 | 1,270 | 1,810 | 1,900 | 720 |
| 4 | 1,210 | 1,200 | 1,330 | 1,910 | 2,000 | 1930 |
| 5 | 1,200 | 1,020 | 1,320 | 1,890 | 1,980 | 1,910 |
| 6 | 980 | 940 | 1,080 | 1,540 | 1,620 | 980 |
| 7 | 950 | 960 | 1,050 | 1,500 | 1,570 | 1,520 |
| 8 | 1,050 | 1,100 | 1,160 | 1,650 | 1,730 | 1,670 |
| 9 | 940 | 1,120 | 1,030 | 1,480 | 1,550 | 1,500 |
| 10 | 930 | 1,010 | 1,020 | 1,460 | 1,530 | 1,480 |

Referring to Table 1, it can be seen that when W′/W was 10% to 70%, as W′/W was increased, BDV was also increased, and BDV was improved by maximally 65% as compared to Comparative Example in which no space part was formed and W/W′ was 0%.

Further, when W′/W was 90%, a decrease in BDV was observed, and after sintering, cracks occurred in the vicinity of the internal electrodes that became narrow due to the space part. It may be seen that the cracks occurred in samples of which BDV was rapidly deteriorated.

The following Table 2 shows ESD measurement results according to changes in a ratio of a width W′ of the space part shown in FIG. 8 to a width W of the internal electrode from 0% to 90%.

TABLE 2

| | ESD Level | | | | | | |
|---|---|---|---|---|---|---|---|
| | 800 V | 1000 V | 1200 V | 1400 V | 1600 V | 1800 V | 2000 V |
| 0% | OK | NG | — | — | — | — | — |
| 10% | OK | NG | — | — | — | — | — |
| 20% | OK | OK | NG | — | — | — | — |
| 50% | OK | OK | OK | NG | — | — | — |
| 70% | OK | OK | OK | OK | OK | OK | NG |
| 90% | OK | OK | OK | NG | — | — | — |

Referring to Table 2, it can be seen that as W′/W was increased, the ESD level was increased. However, in the case in which W′/W was 90%, the ESD level was evaluated as being lower than a sample of which W′/W was 70%. This may be due to cracks occurred at the time of sintering.

Next, the first and second external electrodes 131 and 132 may be formed to contact portions of the plurality of first and second internal electrodes 121 and 122 exposed to the first and second end surfaces of the ceramic body 110 to thereby be electrically connected thereto, respectively.

Here, a plating layer may be further formed on the first and second external electrodes 131 and 132, as necessary.

As set forth above, according to exemplary embodiments of the present disclosure, an internal electrode may include a space part disposed adjacent to a portion thereof exposed to one end surface of a ceramic body so as to be not overlapped with an internal electrode having a different polarity in the space part, such that a decrease in BDV and ESD resulting from miniaturization of the multilayer ceramic electronic component may be suppressed, and a deviation in overlap areas between vertically adjacent internal electrodes resulting from a reduction of precision in printing and stacking processes may be minimized. Therefore, the overlap areas may be significantly uniform, whereby the occurrence of uneven capacitance distribution may be decreased.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic electronic component comprising:
a ceramic body including a plurality of dielectric layers; and
first and second internal electrodes disposed to be alternately exposed to both end surfaces of the ceramic body, having at least one of the dielectric layers interposed therebetween,
wherein the second internal electrode includes a space part disposed to be adjacent to a portion thereof exposed to one end surface of the ceramic body so as to be not overlapped with the first internal electrode in the space part.

2. The multilayer ceramic electronic component of claim 1, wherein the first and second internal electrodes have the same width.

3. The multilayer ceramic electronic component of claim 1, wherein when a width of the second internal electrode is defined as W and a width of the space part is defined as W′, W′/W is 0.7 or less.

4. The multilayer ceramic electronic component of claim 1, wherein the first internal electrode includes a space part disposed to be adjacent to a portion thereof exposed to the other end surface of the ceramic body so as to be not overlapped with the second internal electrode.

5. The multilayer ceramic electronic component of claim 4, wherein when a width of the first internal electrode is defined as W and a width of the space part is defined as W′, W′/W is 0.7 or less.

6. The multilayer ceramic electronic component of claim 1, further comprising first and second external electrodes formed on the end surfaces of the ceramic body and connected to the first and second internal electrodes, respectively.

7. A method of manufacturing a multilayer ceramic electronic component, the method comprising:
forming a plurality of first internal electrode films on a first ceramic sheet at a predetermined interval;
forming a plurality of second internal electrode films on a second ceramic sheet at a predetermined interval, each second internal electrode film including a second space part;
preparing a multilayer body by stacking a plurality of the first and second ceramic sheets to be alternately offset in a length direction and pressing the stacked sheets;
preparing a ceramic body having first and second internal electrodes by cutting the multilayer body to separate regions thereof corresponding to individual chips while the first and second internal electrode films are alternately exposed to both end surfaces of the ceramic body; and
sintering the ceramic body,
wherein the multilayer body is cut so that the second space part is positioned adjacent to a portion of the second internal electrode film exposed to one end surface of the ceramic body.

8. The method of claim 7, wherein the first and second internal electrode films are formed to have the same width.

9. The method of claim 7, wherein each of the plurality of first internal electrode films formed on the first ceramic sheet includes a first spaced part,
the multilayer body is cut so that the first space part is positioned adjacent to a portion of the first internal electrode film exposed the other end surface of the ceramic body.

10. The method of claim 7, wherein when a width of the second internal electrode is defined as W and a width of the second space part is defined as W′, W′/W is 0.7 or less.

11. The method of claim 7, further comprising forming first and second external electrodes on the end surfaces of the ceramic body to be connected to the first and second internal electrodes, respectively.

12. A method of manufacturing a multilayer ceramic electronic component, the method comprising:
forming a plurality of first internal electrode films including two adjacent first space parts on a first ceramic sheet at a predetermined interval;
forming a plurality of second internal electrode films including two adjacent second space parts on a second ceramic sheet at a predetermined interval;
preparing a multilayer body by stacking a plurality of the first and second ceramic sheets while the first and second space parts are alternately offset in a length direction and pressing the stacked sheets;
preparing a ceramic body having first and second internal electrodes by cutting the multilayer body to separate regions thereof corresponding to individual chips while the first and second internal electrode films are alternately exposed to both end surfaces of the ceramic body; and
sintering the ceramic body,
wherein the multilayer body is cut so that the first and second space parts are positioned adjacent to portions of the first and second internal electrode films exposed to the end surfaces of the ceramic body, respectively.

13. The method of claim 12, wherein the first and second internal electrode films are formed to have the same width.

14. The method of claim 12, wherein when a width of the first and second internal electrodes is defined as W and a width of the first and second space parts is defined as W′, W′/W is 0.7 or less.
